(19) United States
(12) Patent Application Publication
(10) Pub. No.: US 2026/0200419 A1
(43) Pub. Date: Jul. 16, 2026

(54) VEHICLE-MOUNTED APPARATUS, INFORMATION PROCESSING METHOD, AND PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yuta TANINAKA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/133,388

(22) PCT Filed: Nov. 9, 2023
(86) PCT No.: PCT/JP2023/040334

§ 371 Date: May 28, 2025

(30) Foreign Application Priority Data
Nov. 29, 2022 (JP) 2022-190337

(51) Int. Cl. B60R 16/03

(52) U.S. Cl. CPC B60R 16/03

(57) ABSTRACT

A vehicle-mounted apparatus is mounted in a vehicle and is connected to vehicle-mounted ECUs, which are connected to a vehicle-mounted network, so as to communicate with the vehicle-mounted ECUs. The vehicle-mounted apparatus includes a control unit configured to perform processing relating to supplying of power to the vehicle-mounted ECUs. The control unit acquires a current value of a current flowing through a vehicle mounted ECU corresponding to a service executed in the vehicle, acquires an available capacity, which can be used to execute the service, of a power source apparatus mounted in the vehicle, determines whether to continue supplying power to the vehicle-mounted ECU corresponding to the service based on the acquired available capacity and the current value, and performs processing relating to supplying of power in keeping with a determination result.

### CROSS-REFERENCE TO RELATED APPLICATIONS

This application is the U.S. national stage of PCT/JP2023/040334 filed on Nov. 9, 2023, which claims priority of Japanese Patent Application No. JP 2022-190337 filed on Nov. 29, 2022, the contents of which are incorporated herein.

### TECHNICAL FIELD

The present disclosure relates to a vehicle-mounted apparatus, an information processing method, and a program.

### BACKGROUND

JP 2021-182679A discloses a vehicle-mounted system in which a plurality of ECUs (Electronic Control Units) are connected to a communication bus. ECUs communicate with other ECUs via the communication bus.

The vehicle-mounted system according to JP 2021-182679A has a problem in that no consideration is given to consumption of power by vehicle-mounted ECUs corresponding to services executed in a vehicle.

### SUMMARY

It is an object of the present disclosure to provide a vehicle-mounted apparatus and the like that are capable of efficiently executing processing relating to the supplying of power to vehicle-mounted ECUs corresponding to services executed in a vehicle.

A vehicle-mounted apparatus according to an aspect of the present disclosure is a vehicle-mounted apparatus that is mounted in a vehicle and is connected to vehicle-mounted ECUs, which are connected to a vehicle-mounted network, so as to communicate with the vehicle-mounted ECUs, the vehicle-mounted apparatus including a control unit configured to perform processing relating to supplying of power to the vehicle-mounted ECUs, wherein the control unit: acquires a current value of a current flowing through a vehicle-mounted ECU corresponding to a service executed in the vehicle; acquires an available capacity, which can be used to execute the service, of a power source apparatus mounted in the vehicle; determines whether to continue supplying power to the vehicle-mounted ECU corresponding to the service based on the acquired available capacity and the current value; and performs processing relating to supplying of power in keeping with a determination result.

### Advantageous Effects

According to an aspect of the present disclosure, there is provided a vehicle-mounted apparatus and the like that are capable of efficiently executing processing relating to the supplying of power to vehicle-mounted ECUs corresponding to services executed in a vehicle.

### BRIEF DESCRIPTION OF DRAWINGS

FIG. 1 is a schematic diagram depicting an example configuration of a vehicle-mounted system including a vehicle-mounted apparatus and the like according to a first embodiment.

FIG. 2 is a block diagram depicting the internal configuration of the vehicle-mounted apparatus.

FIG. 3 is a flowchart depicting the processing of a control unit of the vehicle-mounted apparatus.

FIG. 4 is a diagram useful in explaining a service table according to a second embodiment (which relates to priority rankings for a plurality of services).

FIG. 5 is a flowchart depicting the processing of a control unit in a vehicle-mounted apparatus.

FIG. 6 is a schematic diagram depicting the configuration of a vehicle-mounted system including a vehicle-mounted apparatus and the like according to a third embodiment (where a relaying apparatus outputs a sleep signal).

FIG. 7 is a flowchart depicting the processing of the control unit of the vehicle-mounted apparatus.

FIG. 8 is a schematic diagram depicting the configuration of a vehicle-mounted system including a vehicle-mounted apparatus and the like according to a fourth embodiment (where power control is implemented by a relaying apparatus).

FIG. 9 is a flowchart depicting the processing of the control unit of the vehicle-mounted apparatus (a relaying apparatus).

### DETAILED DESCRIPTION OF PREFERRED EMBODIMENTS

Several embodiments of the present disclosure will first be listed and described in outline. The embodiments described below may be freely combined, at least in part.

In a first aspect, a vehicle-mounted apparatus according to an aspect of the present disclosure is a vehicle-mounted apparatus that is mounted in a vehicle and is connected to vehicle-mounted ECUs, which are connected to a vehicle-mounted network, so as to communicate with the vehicle-mounted ECUs, the vehicle-mounted apparatus including a control unit configured to perform processing relating to supplying of power to the vehicle-mounted ECUs, wherein the control unit: acquires a current value of a current flowing through a vehicle-mounted ECU corresponding to a service executed in the vehicle; acquires an available capacity, which can be used to execute the service, of a power source apparatus mounted in the vehicle; determines whether to continue supplying power to the vehicle-mounted ECU corresponding to the service based on the acquired available capacity and the current value; and performs processing relating to supplying of power in keeping with a determination result.

In this aspect, the vehicle-mounted apparatus is equipped with a control unit that performs processing relating to the supplying of power to a plurality of vehicle-mounted ECUs connected to a vehicle-mounted network, and functions as a power control apparatus that controls the activation and stopping of the vehicle-mounted ECUs by starting or cutting off the supplying of power to such vehicle-mounted ECUs. The vehicle-mounted apparatus is connected to a power source apparatus, such as a lead acid battery or an alternator, via a power supplying line and functions as a power distributing apparatus that distributes power supplied from the power source apparatus via the power supplying line to a plurality of vehicle-mounted ECUs disposed downstream in the direction in which current flows. The vehicle-mounted apparatus that functions as a power distributing apparatus branches an electric wire extending from the power source apparatus into a plurality of electric wires, with each of these branched electric wires (or “branch electric wires”) being connected via a connector to a corresponding vehicle-mounted ECU. Out of the branched electric wires, current sensors, for example, are disposed on electric wires which are connected to the vehicle-mounted ECUs corresponding to a service executed in the vehicle. The control unit of the vehicle-mounted apparatus periodically, cyclically, or regularly acquires a current value (a[A]) detected by a current sensor, and calculates an integral of the current value (F[C]=a[A]*E[s]) for a predetermined unit processing time (the sampling period: E[s]). When calculating the integral of the current value, the control unit of the vehicle-mounted apparatus is not limited to using the only most recently acquired current value (or “present current value”), and may calculate an average value (a moving average) of current values acquired in a plurality of measurements (for example three times) traced back from the present time, and use this average value to calculate the integral of the current values. As one example, when a plurality of vehicle-mounted ECUs (ECUa, ECUb, ECUc) are activated (woken up) to execute a single service, the control unit of the vehicle-mounted apparatus acquires the respective current values (a [A], b [A], c [A]) detected by the current sensors disposed on the branched electric wires to which this plurality of vehicle-mounted ECUs (ECUa, ECUb, ECUc) are connected. In this case, the integral of the current values is the sum of these current values (a[A], b[A], c[A]), that is, F[C]=(a+b+c)[A]*E[s]. A storage unit of the vehicle-mounted apparatus stores the available capacity that can be used to execute a service relative to the battery capacity (the fully charged capacity) of the power source apparatus, and the control unit of the vehicle-mounted apparatus obtains the available capacity by referring to the storage unit. The available capacity is an amount of power that is determined based on the proportion of the battery capacity (the fully charged capacity) of the power source apparatus that can be used by the vehicle-mounted ECUs corresponding to a service in a state where, for example, the vehicle is stopped (that is, the IG switch is off). In other words, the available capacity is a value calculated by multiplying the battery capacity of the power source apparatus (the fully charged capacity: x [Ah]) by the available proportion (G [%]), that is, H [C]=x [Ah]*3600 * (G/100). In this way, when the vehicle is stopped, for example, the control unit of the vehicle-mounted apparatus first supplies power to the vehicle-mounted ECUs corresponding to a service to execute the service, and calculates the integral of the amount of current flowing in such vehicle-mounted ECUs (that is, the power consumption). The control unit of the vehicle-mounted apparatus determines whether to continue supplying power to the vehicle-mounted ECUs corresponding to the service, based on the calculated integral of the current values and the available capacity. This means that even when the vehicle is parked stopped, or the like, for a power source apparatus composed of a lead acid battery or the like, services can be executed within an appropriate range while preventing the battery from going flat or deteriorating, which suppresses a drop in the value of such services.

In a second aspect, in a vehicle-mounted apparatus according to an aspect of the present disclosure, a power supplying cutoff unit for cutting off a supplying of power from the power source apparatus is provided for the vehicle-mounted ECU corresponding to the service, and the processing relating to the supplying of power by the control unit includes control of the power supplying cutoff unit to cut off the supplying of power.

According to this aspect, power supplying cutoff units that cut off the supplying of power to vehicle-mounted ECUs are connected to the electric wires that extend from the vehicle-mounted apparatus, which functions as a power distributing apparatus, toward the vehicle-mounted ECUs. That is, a power supplying cutoff unit is connected to each vehicle-mounted ECU corresponding to a service. Each of the power supplying cutoff units and the vehicle-mounted apparatus are connected to communicate with each other via signal lines, such as a serial cable, a wire harness, or a conductive cable (direct line) that transmits a single signal. As examples, each power supplying cutoff unit is composed of a semiconductor relay, a mechanical relay, or an open/close switch, and transitions in response to signals outputted from the vehicle-mounted apparatus between a connected state (a power supplying state), where a vehicle-mounted ECU is supplied with power by the power source apparatus, and a cutoff state (a non-power supplying state), where the supplying of power from the power source apparatus is cut off. When a power supplying cutoff unit is constructed of a relay or the like, the connected state where a vehicle-mounted ECU is supplied with power from the power source apparatus corresponds to an on state of the relay, and the cutoff state where the supplying of power from the power source apparatus is cut off corresponds to an off state of the relay. In this way, control of a power supplying cutoff unit by the control unit of the vehicle-mounted apparatus, that is, control to cut off the supplying of power (that is, to turn off the relay) and control to start the supplying of power (that is, to turn on the relay), is performed in keeping with the configuration, characteristics, and specification of the power supplying cutoff units. As one example, to execute a specified service, the control unit of the vehicle-mounted apparatus performs control to place the power supplying cutoff units connected to the vehicle-mounted ECUs to be activated to start the supplying of power (that is, to turn on the relays). If the control unit of the vehicle-mounted apparatus has determined, based on the acquired available capacity and the current values, to not continue supplying power to the vehicle-mounted ECUs corresponding to a service, as the processing relating to the supplying of power, the control unit controls the power supplying cutoff units connected to the vehicle-mounted ECUs corresponding to such service to cut off the supplying of power. By doing so, it is possible to efficiently perform the processing relating to the supplying of power to vehicle-mounted ECUs corresponding to a service, to enable services to be executed within an appropriate range while preventing problems such as the battery going flat, which suppresses a drop in the value of the services.

In a third aspect, in a vehicle-mounted apparatus according to an aspect of the present disclosure, the processing by the control unit relating to the supplying of power includes processing that outputs a sleep signal via the vehicle-mounted network to a vehicle-mounted ECU corresponding to a service.

According to this aspect, a vehicle-mounted ECU connected to the vehicle-mounted network receives an activation signal, such as a wake-up signal, and a stop signal, such as a sleep signal, transmitted from the vehicle-mounted apparatus via the vehicle-mounted network. On receiving a wake-up signal or a sleep signal transmitted from the vehicle-mounted apparatus, a vehicle-mounted ECU transitions to the wake-up state (activated state) or the sleep state (a stopped or standby state). A vehicle-mounted ECU in the sleep state does not receive power from the power source apparatus, so that the supplying of power is effectively cut off. To execute a specified service, for example, the control unit of the vehicle-mounted apparatus transmits a wake-up signal to the vehicle-mounted ECUs that are to be activated. If the control unit of the vehicle-mounted apparatus has determined, based on the acquired available capacity and current values, to not continue supplying power to the vehicle-mounted ECUs corresponding to a service, the control unit performs processing relating to the supplying of power, such as outputting (transmitting) a sleep signal to the vehicle-mounted ECUs corresponding to that service, which places such vehicle-mounted ECUs into a sleep state (a stopped or standby state) and effectively cuts off the supplying of power. By doing so, it is possible to efficiently perform the processing relating to the supplying of power to the vehicle-mounted ECUs corresponding to a service, to execute services within an appropriate range while preventing problems such as the battery going flat, which suppresses a drop in the value of services.

In a fourth aspect, in a vehicle-mounted apparatus according to an aspect of the present disclosure, the control unit acquires current values, which are cyclically detected, during execution of the service, calculates cumulative power usage based on the acquired plurality of current values, calculates a sustainable time, for which supplying of power to the vehicle-mounted ECU corresponding to the service is sustainable, based on the available capacity, the cumulative power usage, and presently acquired current values, and executes processing for cutting off supplying of power to the vehicle-mounted ECU corresponding to the service when the calculated sustainable time is below a predetermined value.

According to this aspect, the control unit of the vehicle-mounted apparatus cyclically acquires current values detected by the current sensor and thereby acquires a plurality of current values arranged in a time series. As one example, every time a current value is acquired, the control unit of the vehicle-mounted apparatus multiplies the current value by a sampling period (E[s]) to calculate an integral of the current value (F(n)[A*s]) for each unit processing period which corresponds to the sampling period. The control unit of the vehicle-mounted apparatus starts executing a service while the vehicle is stopped, for example, cyclically acquires the current values and repeatedly calculates the integrals, and calculates a cumulative power usage for the present time by summing the integrals (F(1), F(2), F(3), . . . F(n)) from the start of execution of the service to the present time (F_ALL(n)=F(1)+F(2)+F(3) . . . +F(n)). The control unit of the vehicle-mounted apparatus calculates the sustainable time (K[s]) for which power can be supplied to the vehicle-mounted ECUs corresponding to the service, as one example by dividing a value (remaining power: H-F_ALL), which has been obtained by subtracting the cumulative power usage from the available power amount, by the most recently (presently) acquired current values ((a+b+c) [A]). The storage unit of the vehicle-mounted apparatus stores a predetermined value (for example, one minute) that is set in advance as a threshold for the sustainable time, and if the sustainable time (K[s]) is less than this predetermined value (1 minute, which is 60[s]), the control unit of the vehicle-mounted apparatus determines to not continue supplying power to the vehicle-mounted ECUs corresponding to the service. If the sustainable time (K[s]) is equal to or greater than the predetermined value (one minute, which is 60[s]), the control unit of the vehicle-mounted apparatus determines to continue supplying power to the vehicle-mounted ECUs corresponding to the service. By calculating the sustainable time for supplying power to the vehicle-mounted ECUs corresponding to a service in this way, it is possible to efficiently determine whether to continue the supplying of power to the vehicle-mounted ECUs corresponding to a service.

In a fifth aspect, in a vehicle-mounted apparatus according to an aspect of the present disclosure, a plurality of services are executed at the vehicle, and the control unit identifies vehicle-mounted ECUs to which supplying of power is to be cut off in keeping with priority rankings set for the plurality of services, and performs processing that cuts off the supplying of power to the identified vehicle-mounted ECUS.

In this aspect, when a plurality of services are being executed while the vehicle is stopped, for example, the control unit of the vehicle-mounted apparatus identifies the vehicle-mounted ECUs to which the supplying of power is to be cut off in keeping with priority rankings set for such plurality of services. Information relating to the priority rankings of services is set in advance in a storage unit of the vehicle-mounted apparatus, and by referring to the storage unit, the control unit of the vehicle-mounted apparatus can grasp the priority rankings of the services. When the control unit of the vehicle-mounted apparatus has determined to not continue supplying power to vehicle-mounted ECUs corresponding to a service in a state where a plurality of services are being executed, the control unit identifies, for example, the service with the lowest priority ranking (priority) and identifies the vehicle-mounted ECUs corresponding to such low priority service. The control unit of the vehicle-mounted apparatus performs processing relating to the supplying of power, that is, processing to cut off the supplying of power, for the vehicle-mounted ECUs corresponding to the identified low priority service. In this way, even if a plurality of services are being executed, it is possible to identify the vehicle-mounted ECUs to which the supplying of power should be cut off in keeping with the priority rankings (priorities) of services without the supplying of power being uniformly cut off to every vehicle-mounted ECU, and to perform processing to cut off the supplying of power to the identified vehicle-mounted ECUs. By doing so, it is possible to stop services in order starting with services with low priority rankings (priorities), which makes it possible to execute services in an appropriate range while preventing problems such as the battery going flat, which suppresses a drop in the value of services.

In a sixth aspect, in a vehicle mounted apparatus according to an aspect of the present disclosure, the control unit cyclically calculates a sustainable time for supplying of power to the vehicle-mounted ECUs corresponding to each of the plurality of services and outputs information relating to the calculated sustainable times for each of the services, and the information relating to each of the sustainable times includes a sustainable time for when only one of the services is executed and a sustainable time for when a plurality of the services are executed in combination.

According to this aspect, when a plurality of services are being executed while the vehicle is stopped, for example, the control unit of the vehicle-mounted apparatus cyclically calculates the sustainable time for the supplying of power to the vehicle-mounted ECUs corresponding to each of the plurality of services, and outputs information relating to the respective sustainable times to, for example, an HMI apparatus, such as a display apparatus, or a mobile terminal or the like held by the operator of the vehicle. Since the information relating to the respective sustainable times includes the sustainable time when only a single service is executed or the sustainable time when a plurality of services are executed in combination, the operator of the vehicle can be efficiently notified of information relating to each of the plurality of services being executed.

In a seventh aspect, in a vehicle-mounted apparatus according to an aspect of the present disclosure, a relaying apparatus for relaying communication data to be transmitted and received between the plurality of vehicle-mounted ECUs is connected to the vehicle-mounted network, and as the processing relating to the supplying of power, the control unit outputs a power control instruction to the relaying apparatus to cause the relaying apparatus to execute processing for outputting a sleep signal to a vehicle-mounted ECU corresponding to the service.

According to this aspect, the relaying apparatus is connected to the vehicle-mounted network and the relaying apparatus may distribute power from the vehicle-mounted apparatus that functions as a power distributing apparatus. By doing so, the vehicle-mounted apparatus can acquire the current value of the current flowing through the relaying apparatus. The relaying apparatus has a function of transmitting a wake-up signal and a sleep signal to each of the plurality of vehicle-mounted ECUs via the vehicle-mounted network. When, as a processing relating to the supplying of power, the vehicle-mounted apparatus performs processing of cutting off the supplying of power to the vehicle-mounted ECUs corresponding to a service, the vehicle-mounted apparatus outputs, to the relaying apparatus, a power control instruction that identifies the vehicle-mounted ECUs to which the supplying of power is to be cut off. That is, the power control instruction includes information for identifying the vehicle-mounted ECUs to which the supplying of power is to be cut off, such as the ECU IDs, IP addresses, or bus numbers of the communication lines to which such vehicle-mounted ECUs are connected. The relaying apparatus that has acquired the power control instruction from the vehicle-mounted apparatus outputs a sleep signal to the vehicle-mounted ECUs that correspond to the service to be stopped, that is, the vehicle-mounted ECUs to which the supplying of power is to be cut off, in keeping with the power control instruction. By doing so, it is possible to efficiently cut off the supplying of power to the vehicle-mounted ECUs and to execute services within an appropriate range while preventing problems such as the battery going flat, which suppresses a drop in the value of services. When doing so, for vehicle-mounted ECUs provided with a power supplying cutoff unit, the control unit of the vehicle-mounted apparatus may control the power supplying cutoff units to cut off the supplying of power. In this way, in keeping with the configuration of the vehicle-mounted ECU to which the supplying of power is to be cut off, the relaying apparatus can output a sleep signal or the vehicle-mounted apparatus can control the power supplying cutoff unit to cut off the supplying of power, which makes it possible to flexibly comply to the configurations or product specifications of the vehicle-mounted ECUs.

In an eighth aspect, in a vehicle-mounted apparatus according to an aspect of the present disclosure, the control unit performs processing for relaying communication data that is transmitted and received between a plurality of vehicle-mounted ECUs, the vehicle-mounted ECU corresponding to the service is provided with a power supplying cutoff unit for cutting off supplying of power from the power source apparatus, a power supplying cutoff apparatus, which is conductively connected to the power supplying cutoff unit, is mounted in the vehicle, the control unit acquires a current value of a current flowing in the vehicle-mounted ECU corresponding to the service from the power supplying cutoff apparatus, determines whether to continue supplying power to the vehicle-mounted ECU corresponding to the service based on the acquired available capacity and the current value, and performs processing relating to supplying of power in keeping with a result of the determining, and the processing relating to the supplying of power includes: processing that outputs, via the vehicle-mounted network, a sleep signal to the vehicle-mounted ECU corresponding to the service; and processing that outputs a power control instruction to the power supplying cutoff apparatus to cause the power supplying cutoff apparatus to execute processing that cuts off supplying of power at the power supplying cutoff unit.

According to this aspect, the relaying apparatus functions as a power control apparatus that controls the starting and stopping of the vehicle-mounted ECUs. The detection of the current value of the current flowing through each vehicle-mounted ECU is performed by the power supplying cutoff apparatus. The power supplying cutoff apparatus is connected to a power source apparatus via a power supplying line, and functions as a power distributing apparatus that distributes power supplied from the power source apparatus via the power supplying line to a plurality of vehicle-mounted ECUs that are disposed downstream in the direction in which current flows. At least some of the plurality of vehicle-mounted ECUs corresponding to services are provided with a power supplying cutoff unit for cutting off the supplying of power from the power source apparatus, and the power supplying cutoff unit and the power supplying cutoff apparatus are conductively connected. The control unit of a relaying apparatus (vehicle-mounted apparatus) that functions as a power control apparatus determines, based on the available capacity and the current values acquired from the power supplying cutoff apparatus, whether to continue supplying power to the vehicle-mounted ECUs corresponding to a service. Accordingly, the processing can be performed as distributed processing with an apparatus (the power supplying cutoff apparatus), which is responsible for detecting the current values, and a vehicle-mounted apparatus (relaying apparatus), which determines whether to continue the supplying of power and performs processing relating to the supplying of power in keeping with the result of the determination, as separate apparatuses. In this case, the power supplying cutoff apparatus performs the processing to cut off the supplying of power to the power supplying cutoff units in keeping with a power control instruction from the relaying apparatus (the vehicle-mounted apparatus), which reduces the processing load at the power supplying cutoff apparatus. Distribution of power to the relay apparatus (vehicle-mounted apparatus) may be performed by the power supplying cutoff apparatus (power distributing apparatus), or the relaying apparatus (vehicle-mounted apparatus) may be connected to the power source apparatus or a fuse box or the like without being connected via the power supplying cutoff apparatus (power distributing apparatus).

In a ninth aspect, an information processing method according to an aspect of the present disclosure causes a computer connected to vehicle-mounted ECUs, which are connected to a vehicle-mounted network, so as to communicate with the vehicle-mounted ECUs to execute processing including: acquiring a current value of a current flowing through a vehicle-mounted ECU corresponding to a service executed in the vehicle; acquiring an available capacity, which can be used to execute the service, of a power source apparatus mounted in the vehicle; determining whether to continue supplying power to the vehicle-mounted ECU corresponding to the service based on the acquired available capacity and the current value; and performing processing relating to supplying of power in keeping with a result of the determining.

According to this aspect, it is possible to provide an information processing method that causes a computer to function as a vehicle-mounted apparatus that efficiently performs processing relating to the supplying of power to vehicle-mounted ECUs corresponding to a service executed in the vehicle.

In a tenth aspect, a program according to an aspect of the present disclosure causes a computer connected to vehicle-mounted ECUs, which are connected to a vehicle-mounted network, so as to communicate with the vehicle-mounted ECUs to execute processing including: acquiring a current value of a current flowing through a vehicle-mounted ECU corresponding to a service executed in the vehicle; acquiring an available capacity, which can be used to execute the service, of a power source apparatus mounted in the vehicle; determining whether to continue supplying power to the vehicle-mounted ECU corresponding to the service based on the acquired available capacity and the current value; and performing processing relating to supplying of power in keeping with a result of the determining.

According to this aspect, it is possible to provide a program that causes a computer to function as a vehicle-mounted apparatus that efficiently performs processing relating to the supplying of power to vehicle-mounted ECUs corresponding to a service executed in the vehicle.

The present disclosure is described in detail below with reference to the accompanying drawings which depict specific embodiments. A vehicle-mounted apparatus 1 according to embodiments of the present disclosure is described below with reference to the drawings. Note that the present disclosure is not limited to the embodiments described here, is indicated by the range of the patent claims, and is intended to include all modifications within the meaning and scope of the patent claims and their equivalents.

### FIRST EMBODIMENT

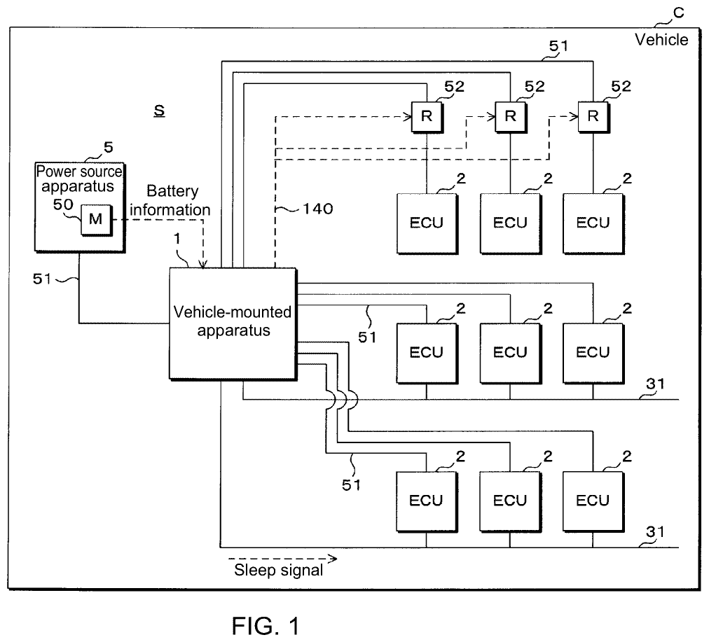

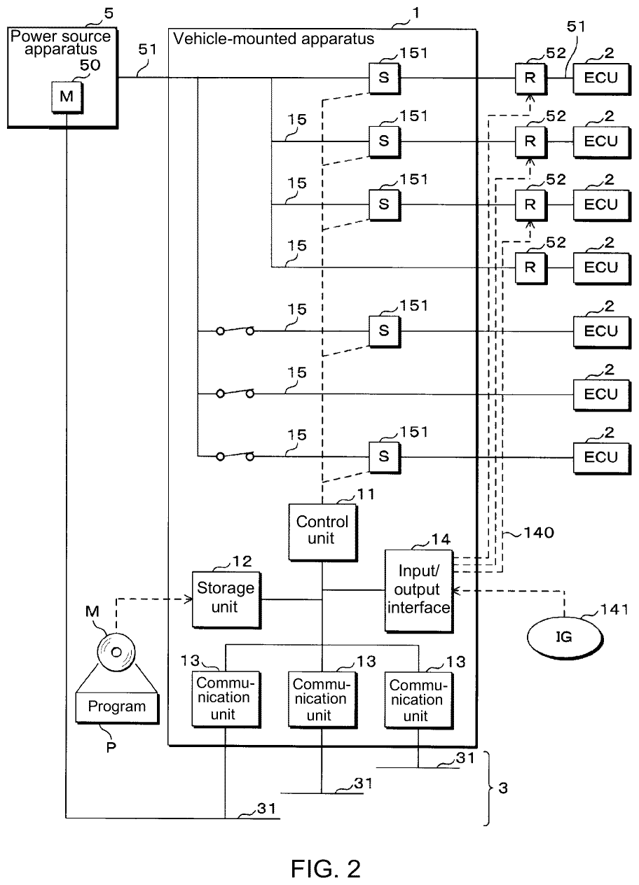

Specific embodiments of the present disclosure are described below with reference to the drawings. FIG. 1 is a schematic diagram depicting an example configuration of a vehicle-mounted system S including the vehicle-mounted apparatus 1 and the like according to a first embodiment. FIG. 2 is a block diagram depicting the internal configuration of the vehicle-mounted apparatus 1. The vehicle-mounted system S is composed of the vehicle-mounted apparatus 1, which is mounted in a vehicle C, a vehicle-mounted ECU 2, and a vehicle-mounted network 3 that connects these elements for communication purposes. The vehicle-mounted network 3 is constructed of a plurality of communication lines 31. When communication is performed on the vehicle-mounted network 3 according to a communication protocol, as examples CAN (Controller Area Network) or CAN-FD, the communication lines 31 correspond to a CAN bus.

The vehicle C is equipped with a power source apparatus 5 composed of a lead acid battery, an alternator, a rechargeable battery, or the like. The power source apparatus 5 and the vehicle-mounted apparatus 1 are connected by a power supplying line 51. The power source apparatus 5 and the vehicle-mounted apparatus 1 are not limited to being directly connected by the power supplying line 51, and may be indirectly connected via a junction box, such as a relay box or a fuse box, provided between the power source apparatus 5 and the vehicle-mounted apparatus 1. The vehicle-mounted apparatus 1 and a plurality of vehicle-mounted ECUs are connected by power supplying lines 51 so that the vehicle-mounted apparatus 1 distributes power to the plurality of vehicle-mounted ECUs. That is, the vehicle-mounted apparatus 1 functions as a power distributing apparatus that distributes power supplied from the power source apparatus 5 via the power supplying line 51 to the plurality of vehicle-mounted ECUs disposed downstream in the direction in which current flows.

The power supplying line 51 that extends from the power source apparatus 5 branches inside the vehicle-mounted apparatus 1 (a power distributing apparatus), with internal electric wires (or “branch electric wires 15”) provided as branches being connected via connectors or the like to the vehicle-mounted ECUs 2. The branch electric wires 15 are provided with current detecting units 151 composed of current sensors or the like. The current detecting units 151 do not need to be provided on every branch electric wire 15 and may be disposed only on the branch electric wires 15 to which a vehicle-mounted ECU corresponding to a service executed in the vehicle C is connected.

The connectors of the vehicle-mounted apparatus 1 and the respective vehicle-mounted ECUs 2 are connected by the power supplying lines 51, with the power supplying lines 51 being provided with a power supplying cutoff unit 52. The power supplying cutoff units 52 do not need to be provided on every power supplying line 51 that connects the vehicle-mounted apparatus 1 and the vehicle-mounted ECU 2 and may be provided only on the power supplying lines 51 to which a vehicle-mounted ECU corresponding to a service executed in the vehicle C is connected. Additionally, the power supplying cutoff units 52 may be provided only on power supplying lines 51 connected to vehicle-mounted ECUs which correspond to a service executed in the vehicle C but are not connected to the vehicle-mounted network 3 or the like and are therefore incapable of receiving a sleep signal or the like. The vehicle-mounted apparatus 1 is connected to each of the power supplying cutoff units 52, which are provided corresponding to the vehicle-mounted ECUs 2, via signal lines 140 which enable communication. Each power supplying cutoff unit 52 cuts off the supplying of power from the power source apparatus 5 to the vehicle-mounted ECU 2 to which that power supplying cutoff unit 52 is connected in keeping with control by the vehicle-mounted apparatus 1 to cut off the supplying of power. When the supplying of power is cut off, the affected vehicle-mounted ECU 2 is placed in a stopped state.

The power source apparatus 5 includes a power source management unit 50 (or “battery management system”) that manages battery status, such as a state of charge (or “SOC”) and state of health (or “SOH”, a deterioration level) of a battery that constructs the power source apparatus 5. As one example, the power source management unit 50 is constructed of various sensors that detect the internal state of the battery and a microcomputer with a communication function, and outputs (transmits) battery information, such as the state of charge (SOC), which is periodically detected via the vehicle-mounted network 3 to the vehicle-mounted apparatus 1. By doing so, it is possible for a control unit 11 of the vehicle-mounted apparatus 1 to acquire battery information, such as the state of charge (SOC) and state of health (SOH) of the battery that constructs the power source apparatus 5.

Like the vehicle-mounted apparatus 1, described later, the vehicle-mounted ECUs 2 each include a control unit, a storage unit, and a communication unit. Each vehicle-mounted ECU 2 executes a program stored in the storage unit to perform processing for executing various functions or services. The vehicle-mounted ECUs 2 are connected via the vehicle-mounted apparatus 1 (a power distributing apparatus) and the power supplying lines 51 to the power source apparatus 5, which is composed of a lead acid battery, an alternator, a rechargeable battery, or the like. Each vehicle-mounted ECU 2 receives power distributed by the vehicle-mounted apparatus 1 via a power supplying line 51. By receiving a wake-up signal or a sleep signal transmitted from the vehicle-mounted apparatus 1, each vehicle-mounted ECU 2 transitions to a wake-up state (or “activated state”) or a sleep state (or “stopped” or “standby state”).

The vehicle-mounted apparatus 1 functions as a power control apparatus that controls the starting or stopping of the vehicle mounted ECUs, and is an apparatus with a relaying function, such as a CAN gateway. Alternatively, the vehicle-mounted apparatus 1 may be an integrated ECU (or “vehicle computer”) that performs integrated control of the vehicle C and has a relaying function. As another alternative, the vehicle-mounted apparatus 1 may be an individual ECU that is connected under the control of an integrated ECU and disposed in one area of the vehicle C. As yet another alternative, the vehicle-mounted apparatus 1 may be configured as a body ECU or the like that controls body-related actuators of the vehicle C. The vehicle-mounted apparatus 1 may alternatively be a PLB (Power Lan Box) which, in addition to relaying communication, functions as a power distributing apparatus that distributes and relays power outputted from the power source apparatus 5, which may be a rechargeable battery, to supply power to vehicle-mounted apparatuses such as actuators. Vehicle-mounted devices, such as various switches, sensors, or actuators, may be connected to the vehicle-mounted apparatus 1.

The vehicle-mounted apparatus 1 includes the control unit 11, a storage unit 12, a communication unit 13, and an input/output interface 14. The control unit 11 is composed of a CPU (Central Processing Unit), an MPU (Micro Processing Unit), or the like, and performs various control processing, computational processing, and the like by reading and executing a control program P (a program product) and data stored in advance in the storage unit 12.

The storage unit 12 is composed of a volatile memory element, such as RAM (Random Access Memory), or a non-volatile memory element such as ROM (Read Only Memory), EEPROM (Electrically Erasable Programmable ROM) or flash memory, or a combination of such storage devices, and stores in advance the control program P (a program product) and data to be referred to during processing. The control program P (a program product) stored in the storage unit 12 may be a control program P (a program product) that was read from a recording medium M, which is readable by the vehicle-mounted apparatus 1, and then stored in the storage unit 12. Alternatively, the control program P (program product) may be downloaded from an external computer, not illustrated, connected to a communication network, also not illustrated, and stored in the storage unit 12.

The communication unit 13 is an input/output interface that uses a communication protocol such as CAN, CAN-FD, or Ethernet (registered trademark), with the control unit 11 communicating with the vehicle-mounted ECU 2 connected to the vehicle-mounted network 3 via this communication unit 13. A plurality of communication units 13 are provided in the vehicle-mounted apparatus 1, with a communication line 31, such as a CAN bus, connected to each of these communication units 13. The vehicle-mounted apparatus 1 that has a relaying function relays communication data transmitted and received between this plurality of communication units 13 (that is, between the communication lines 31 which are CAN buses or the like).

As one example, the input/output interface 14 is a communication interface for serial communication. The input/output interface 14 includes a plurality of terminals (output terminals) and each of these terminals is connected to a signal line 140 that extends to one of the power supplying cutoff units 52. As examples, each signal line 140 is a serial cable, a wire harness, or a conductive cable (or “direct line”) that transmits a single signal. In addition, the input/output interface 14 may be connected to an IG switch 141 that starts and stops the vehicle C. The input/output interface 14 may be additionally connected to various apparatuses operated by the operator of the vehicle C and to various sensors.

Each of the signal lines 140 is connected to a power supplying cutoff unit 52, which is provided corresponding to one out of the plurality of vehicle-mounted ECUs 2. Each power supplying cutoff unit 52 is disposed between a vehicle-mounted ECU 2 and one of the power source apparatus 5 and ground. As examples, each power supplying cutoff unit 52 is composed of a semiconductor relay, a mechanical relay, or an open/close switch, and transitions in response to signals outputted from the vehicle-mounted apparatus 1 between a connected state, where a vehicle-mounted ECU 2 is supplied with power by the power source apparatus 5, and a cutoff state, where the supplying of power from the power source apparatus 5 is cut off. When a power supplying cutoff unit 52 is constructed of a relay or the like, the connected state where the vehicle-mounted ECU 2 is supplied with power from the power source apparatus 5 corresponds to the on state of the relay, and the cutoff state where the supplying of power from the power source apparatus 5 is cut off corresponds to the off state of the relay. In this way, control of a power supplying cutoff unit 52 by the control unit 11 of the vehicle-mounted apparatus 1, that is, control to cut off the supplying of power (that is, to turn off the relay) and control to start the supplying of power (that is, to turn on the relay), is performed in keeping with the configuration, characteristics, and specification of the power supplying cutoff units 52.

Control to cut off the supplying of power includes control to stop outputting of a duty signal (that is, an on signal) or to output an off signal. When a power supplying cutoff unit 52 is constructed of an n-type field effect transistor (FET), for example, the power supplying cutoff unit 52 (n-type FET) is turned on by applying a gate voltage (or “duty signal”) to the gate terminal. In a state where no gate voltage is applied, the power supplying cutoff unit 52 (n-type FET) is off, which means that the power supplying cutoff unit 52 (n-type FET) is off in the normal state. As other examples, when a power supplying cutoff unit 52 is constructed of a mechanical relay or an open/close switch, if the mechanical relay is a form a relay, the relay will be turned on when a coil current flows in response to an on signal from the vehicle-mounted apparatus 1, which means that the power supplying cutoff unit 52 (such as a mechanical relay) is off in the normal state. Alternatively, if the mechanical relay is a form-b relay, the relay is on in a normal state and is turned off when a coil current flows in response to an off signal from the vehicle-mounted apparatus 1.

The control unit 11 of the vehicle-mounted apparatus 1 causes the power supplying cutoff unit 52 connected to a vehicle-mounted ECU 2 that is to be activated to transition to a state where power is supplied (that is, where the relay is in the on state). If the power supplying cutoff unit 52 is constructed of a semiconductor relay such as a FET, the control unit 11 of the vehicle-mounted apparatus 1 applies (outputs) a gate voltage (or “duty signal”) to the gate terminal of the FET (that is, the power supplying cutoff unit 52) to place the FET in the on state and start the supplying of power from the power source apparatus 5 constructed of a rechargeable battery or the like. When the FET is turned on and the supplying of power commences, the vehicle-mounted ECU 2 to be activated may temporarily enter a sleep state (or “standby state”). The control unit 11 of the vehicle-mounted apparatus 1 may output an activation signal, such as a wake-up signal, via the vehicle-mounted network 3 while maintaining the state where power is being supplied (that is, where the relay is in the on state) without the power supplying cutoff unit 52 to which the vehicle-mounted ECU 2 to be activated is connected cutting off the power supplying path (that is, without the relay entering the off state). The vehicle-mounted ECU 2 to be activated that has received the activation signal (or “startup signal”) transitions from the sleep state (the standby state) to the wake-up state (or “activated state”).

At this time, the vehicle-mounted apparatus 1 performs control to cut off the supplying of power to the power supplying cutoff units 52 connected to vehicle-mounted ECUs 2 aside from the vehicle-mounted ECU 2 to be activated, which means that power is not supplied from the power source apparatus 5 to the vehicle-mounted ECUs 2 connected to such power supplying cutoff units 52. This means that even if an activation signal is outputted via the vehicle-mounted network 3, the vehicle-mounted ECUs 2 connected to the power supplying cutoff units 52 that are in the cutoff state will not be activated, which makes it possible to prevent power being consumed by such vehicle-mounted ECUs 2.

The control unit 11 of the vehicle-mounted apparatus 1 executes a program to function as a power transition manager, and has (includes) a power supplying cutoff control function (or “power supplying cutoff control unit”) and a communication WU/SLP control function (or “communication WU/SLP control unit”). Here, “WU” indicates “wake-up” and “SLP” indicates “sleep”. The power transition manager outputs a wake-up signal or a sleep signal to a vehicle-mounted ECU 2 to cause that vehicle-mounted ECU 2 to transition to a wake up state (or activated state) or a sleep state (or stopped or standby state). Due to such state transitions, the vehicle-mounted ECU 2 is supplied with power by the power source apparatus 5 in the wake-up state (or activated state), and is not supplied with power by the power source apparatus 5 or has reduced power consumption in the sleep state (the stopped or standby state).

Inside the vehicle mounted apparatus 1, a power supplying line 51 that extends from the power source apparatus 5 branches into a plurality of branch electric wires 15. The number of the branch electric wires 15, that is, the number of branches, may correspond to the number of vehicle-mounted ECUs connected to the vehicle-mounted apparatus 1, and as one example may be the same number as the vehicle-mounted ECUs connected to the vehicle-mounted apparatus 1. A current detecting unit 151 is disposed on each branch electric wire 15 which is provided inside the vehicle-mounted apparatus 1 and to which a vehicle-mounted ECU that needs to be activated in keeping with execution of a service is connected. The current detecting unit 151 is a current sensor constructed of a shunt resistor, for example, and outputs a detected current value to the control unit 11 of the vehicle-mounted apparatus 1. The control unit 11 of the vehicle-mounted apparatus 1 periodically acquires a current value from each current detecting unit 151 and is thereby capable of acquiring a current value (that is, power consumption) flowing through the vehicle-mounted ECUs that need to be activated in keeping with the execution of a service.

An appropriate fuse for the value of the current flowing through a branch electric wire 15 or a mechanical relay or the like may also be disposed on a branch electric wire 15. In this case, the fuse or the like and the current detecting unit 151 may be constructed of an IPD (Intelligent Power Device), and such IPD may function as a semiconductor fuse. By using an IPD, it is possible to omit the current detecting circuit that constructs the current detecting unit 151 and a mechanical fuse and the like in such current detecting circuit and also possible to reduce the diameter of a wire harness, such as a branch electric wire 15 or a power supplying line 51, that is connected in front of the IPD.

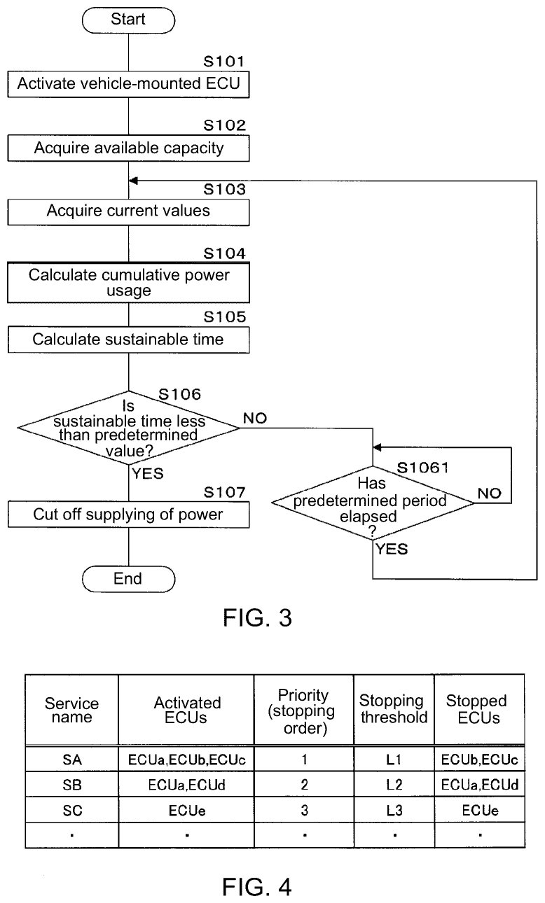

FIG. 3 is a flowchart depicting the processing of the control unit 11 of the vehicle-mounted apparatus 1. As one example, the control unit 11 of the vehicle-mounted apparatus 1 regularly performs the following processing in a state where generation of power (that is, recharging of the battery) by an alternator or the like is not possible, such as when the vehicle C is stopped (that is, when the IG switch 141 is off).

The control unit 11 of the vehicle-mounted apparatus 1 activates the corresponding vehicle-mounted ECUs 2 relating to execution of a service (S101). The control unit 11 of the vehicle-mounted apparatus 1 acquires information (or “a service start request”) relating to a service to be executed by acquiring a signal from a switch connected to the input/output interface 14 or by acquiring communication data, such as a CAN message, via the communication unit 13. As one example, the vehicle-mounted apparatus 1 is a BCU (or “body ECU”) that drives and controls individual ECUs, a plurality of which are disposed in respective areas of the vehicle C, or actuators relating to vehicle body systems, and is constantly supplied with power from the power source apparatus 5.

Via the input/output interface 14, the control unit 11 of the vehicle-mounted apparatus 1 acquires (receives) various signals (or “input signals”) outputted from switches or sensors connected to the input/output interface 14. Alternatively, the control unit 11 of the vehicle-mounted apparatus 1 acquires (receives) communication data such as CAN messages transmitted from the vehicle-mounted ECUs 2 via a communication unit 13, such as a CAN transceiver, and the vehicle-mounted network 3. As one example, these signals or communication data include information relating to various functions or services executed by the vehicle C. Such functions or services are defined in advance as being performed by processing of vehicle-mounted ECUs 2 that are decided in advance, and correspond to information relating to the vehicle-mounted ECUs 2 to be activated when executing such services or the like. Alternatively, these signals or communication data may include information which itself relates to the vehicle-mounted ECUs 2 to be activated. The control unit 11 of the vehicle-mounted apparatus 1 uses the acquired signal or communication data as a trigger to identify the vehicle-mounted ECUs 2 that need to be supplied with power and activated as described below. As an alternative example, the control unit 11 of the vehicle-mounted apparatus 1 may identify the vehicle-mounted ECUs 2 to be activated by referring, based on a service start request acquired from one of the vehicle-mounted ECUs 2, to a service table stored in the storage unit 12.

The control unit 11 of the vehicle-mounted apparatus 1 transmits a wake-up signal, for example, to the identified vehicle-mounted ECUs 2 (that is, corresponding vehicle-mounted ECUs 2 for executing a service). Alternatively, the control unit 11 of the vehicle-mounted apparatus 1 controls the power supplying cutoff units 52 provided on the power supplying lines 51 connected to the identified vehicle-mounted ECUs 2 to start supplying power (that is, to turn on the relays). By doing so, one or a plurality of vehicle-mounted ECUs 2 corresponding to the execution of a service are activated (wake-up).

The control unit 11 of the vehicle-mounted apparatus 1 acquires the available capacity that can be used to execute a service (S102). This available capacity, which can be used to execute a service relative to the battery capacity (that is, the fully charged capacity) of the power source apparatus 5, is stored in the storage unit 12 of the vehicle-mounted apparatus 1. The control unit 11 of the vehicle-mounted apparatus 1 acquires the available capacity by referring to the storage unit 12. The available capacity is an amount of power that is determined based on the proportion of the battery capacity (the fully charged capacity) of the power source apparatus 5 that can be used by the vehicle-mounted ECUs 2 corresponding to the service, and is a value calculated by multiplying the battery capacity (fully charged capacity: x [Ah]) of the power source apparatus 5 by the available proportion (G [%]), that is, H [C]=x[Ah]*3600 * (G/100).

The control unit 11 of the vehicle-mounted apparatus 1 acquires the current value flowing through the vehicle-mounted ECU 2 corresponding to a service (S103). The control unit 11 of the vehicle-mounted apparatus 1 periodically, cyclically, or regularly acquires current values (a[A]) detected by the current detecting units 151, which are current sensors or the like. The control unit 11 of the vehicle-mounted apparatus 1 acquires the current value (a[A]) flowing through a vehicle-mounted ECU 2 corresponding to a service from the current detecting unit 151 disposed on the branch electric wire 15 to which that vehicle-mounted ECU 2 corresponding to the service is connected. When a plurality of vehicle-mounted ECUs 2 (ECUa, ECUb, and ECUc) are activated to execute the same service, the control unit 11 of the vehicle-mounted apparatus 1 acquires the respective current values (a[A], b[A], and c[A]) detected by the current detecting units 151 disposed on the branch electric wires 15 to which such plurality of vehicle-mounted ECUs 2 (ECUa, ECUb, and ECUc) are connected. The control unit 11 of the vehicle-mounted apparatus 1 may store the current values detected by the respective current detecting units 151 in association with identification information, such as the ECU IDs of the corresponding vehicle-mounted ECUs 2 (that is, the vehicle-mounted ECUs 2 to which such current detecting units 151 are connected) and the times (acquisition times) at which such current values were detected as detection history data in the storage unit 12.

Using the current values that have been acquired, the control unit 11 of the vehicle-mounted apparatus 1 calculates an integral of the current values per unit processing time, which is the sampling period (E[s]) for the detection of current values. When a plurality of vehicle-mounted ECUs 2 (ECUa, ECUb, ECUc) are activated, the integral of the current values is the product of the sum of these current values (a[A], b[A], and c[A]) and the sampling period (E[s]), which is to say, F[C]=(a+b+c)[A]*E[s]. The control unit 11 of the vehicle mounted apparatus 1 associates the calculated integral of the current values with the acquisition time at which the current values were acquired and stores the associated data in the storage unit 12. When acquiring the current values, the control unit 11 of the vehicle-mounted apparatus 1 is not limited to using the only most recently acquired current values (or “present current values”), and may calculate an average value (a moving average) of current values acquired in a plurality of measurements (for example, three times) traced back from the present current values to acquire an average value used as the current value flowing in the vehicle-mounted ECUs 2 corresponding to a service.

The control unit 11 of the vehicle-mounted apparatus 1 calculates cumulative power usage based on the acquired current value (S104). The control unit 11 of the vehicle-mounted apparatus 1 calculates the present cumulative power usage (that is, the present value of the cumulative power usage: F_ALL) by adding an integral (F) that has been presently calculated based on acquired current values to a sum of integrals of current values up to the previous calculation (that is, the cumulative power usage up to the previous calculation: F_ALL (previous time)).

The control unit 11 of the vehicle-mounted apparatus 1 calculates a sustainable time for the supplying of power to the vehicle-mounted ECUs 2 corresponding to a service based on the available power amount, the cumulative power usage, and the presently acquired current value (S105). The control unit 11 of the vehicle-mounted apparatus 1 subtracts the cumulative power usage from the available power amount, and divides the result of this subtraction (or “remaining power amount”: H-F_ALL) by the most recently (that is, presently) acquired current value ((a+b+c)[A]) to calculate a value (K[s]=(H-F_ALL)/(a+b+c)) which is the sustainable time for the supplying of power to the vehicle-mounted ECUs 2 corresponding to the service.

The control unit 11 of the vehicle-mounted apparatus 1 determines whether the calculated sustainable time is less than a predetermined value (S106). The storage unit 12 of the vehicle-mounted apparatus 1 stores a predetermined value (L: for example, 1 minute) that is set in advance as a threshold used in a determination performed for the sustainable time. The control unit 11 of the vehicle-mounted apparatus 1 refers to the storage unit 12 to acquire the predetermined value (L) and determines whether the sustainable time is less than this predetermined value (that is, whether K<L). The control unit 11 of the vehicle-mounted apparatus 1 stores the determination result in association with the time at which this determination was made in the storage unit 12.

If the sustainable time is less than the predetermined value (S106: YES), the control unit 11 of the vehicle-mounted apparatus 1 executes processing to cut off the supplying of power to the vehicle-mounted ECUs 2 corresponding to the service (S107). If the sustainable time is less than the predetermined value (K<L), the control unit 11 of the vehicle-mounted apparatus 1 outputs a sleep signal to the vehicle-mounted ECUs 2 corresponding to the service as processing for cutting off the supplying of power to the vehicle-mounted ECUs 2. Alternatively, the control unit 11 of the vehicle-mounted apparatus 1 controls the power supplying cutoff units 52 provided for such vehicle-mounted ECUs 2 to cut off the supplying of power (that is, to turn off the relays) as processing for cutting off the supplying of power to the vehicle-mounted ECUs 2 corresponding to the service. The vehicle-mounted ECUs 2 for which such processing for cutting off the supplying of power has been performed enter a stopped state or a sleep state where power supplied from the power source apparatus 5 is not received, so that the supplying of power is effectively cut off.

If the sustainable time is not less than the predetermined value (S106: NO), the control unit 11 of the vehicle-mounted apparatus 1 determines whether a predetermined period has elapsed (S1061). If the sustainable time is not less than the predetermined value (K<L), that is, if the sustainable time is equal to or greater than the predetermined value (K>L), the control unit 11 of the vehicle-mounted apparatus 1 determines whether the predetermined period has elapsed. This predetermined period corresponds to a determination period for determining whether to cut off the supplying of power to the vehicle-mounted ECUs 2 corresponding to a service. In this way, values for periods that respectively correspond to various processes are stored in the storage unit 12 of the vehicle-mounted apparatus 1, so that by referring to the storage unit 12, the control unit 11 of the vehicle-mounted apparatus 1 can acquire periods corresponding to various processes. If the predetermined period has not elapsed (S1061: NO), the control unit 11 of the vehicle-mounted apparatus 1 performs loop processing to execute the processing of S1061 again. By doing so, the control unit 11 of the vehicle-mounted apparatus 1 performs a standby process until the predetermined period elapses.

If the predetermined period has elapsed (S1061: YES), the control unit 11 of the vehicle-mounted apparatus 1 performs loop processing to execute the processing of S103 again. By doing so, the control unit 11 of the vehicle-mounted apparatus 1 can determine, in cycles of a predetermined length, whether to cut off the supplying of power to the vehicle-mounted ECUs 2 corresponding to a service.

The control unit 11 of the vehicle-mounted apparatus 1 may acquire the state of charge (SOC) of the battery that is the power source apparatus 5 from the power source management unit 50 with a predetermined frequency, as one example, every five periods in which it is repeatedly determined whether the supplying of power is to be cut off. The remaining capacity (D) of the power source apparatus 5 can be calculated by multiplying the state of charge (SOC) by the battery capacity. Alternatively, the control unit 11 of the vehicle-mounted apparatus 1 may acquire the state of health (SOH) from the power source management unit 50 and calculate the remaining capacity (D) of the power source apparatus 5 by multiplying the battery capacity by the state of charge (SOC) and the state of health (SOH). The control unit 11 of the vehicle-mounted apparatus 1 may calculate the difference (or difference in remaining capacity) between the remaining capacity for the presently acquired state of charge (SOC: D_after) and the remaining capacity for the previously acquired state of charge (SOC: D_befor), compare this difference in remaining capacity with the cumulative power usage (F_all) in a period from the time at which the state of charge was previously acquired to the time at which the state of charge has presently been acquired (D_after-(D_befor-F_all)), and correct the cumulative power usage at the present time in keeping with the result of this comparison. If, when power consumption due to the execution of a service is being calculated, a current value (power consumption) flowing through a CAN gateway, an IP switch, or the like has not been detected, the control unit 11 of the vehicle-mounted apparatus 1 may use a value that takes into account an estimated current value at that CAN gateway or the like as a used current value (a value to be reflected in the cumulative power usage).

### SECOND EMBODIMENT

FIG. 4 is a diagram useful in explaining a service table according to a second embodiment (which relates to priority rankings for a plurality of services). In a state such as when the vehicle C is stopped, the control unit 11 of the vehicle-mounted apparatus 1 according to the second embodiment activates a plurality of vehicle-mounted ECUs 2 corresponding to a plurality of services to execute a plurality of services. The control unit 11 of the vehicle-mounted apparatus 1 may refer to a service table stored in the storage unit 12, for example, when activating a plurality of vehicle-mounted ECUs 2 corresponding to a plurality of services.

In a storage region that is accessible by the control unit 11 of the vehicle-mounted apparatus 1, such as the storage unit 12 of the vehicle-mounted apparatus 1, setting information for the vehicle-mounted ECUs 2 that need to be activated to execute services is stored, for example, in table format (as a “service table”). The service table includes management fields, such as “service name”, “activated ECUs”, “priority (stopping order)”, “stopping threshold”, and “stopped ECUs”.

The “service name” management field stores the name of a service (or “service name”) to identify the service to be executed. The control unit 11 of the vehicle-mounted apparatus 1 receives a service start request, for example, by acquiring a signal from a switch connected to the input/output interface 14 or by acquiring communication data such as a CAN message via the communication unit 13 and can identify the service to be executed (started) from the service name included in the service start request.

The “activated ECUs” management field stores the names or identification numbers (ECU IDs) of the vehicle-mounted ECUs 2 to be activated when executing the service (or “service name”) stored in the same record. Such identification numbers (ECU IDs) may use the serial numbers (SN) of the vehicle-mounted ECUs 2. When the communication protocol in the vehicle-mounted network 3 is TCP/IP, the identification numbers (ECU IDs) may be IP addresses or MAC addresses of the vehicle-mounted ECUs 2. The control unit 11 of the vehicle-mounted apparatus 1 can uniquely identify each vehicle-mounted ECU 2 using these ECU IDs.

The “priority (stopping order)” management field stores a numerical value relating to a priority ranking of the service (service name) stored in the same record. In the example described in the present embodiment, a service having a lower priority (stopping order) means that such service has a lower priority ranking, so that the service (here, SA) whose priority (stopping order) is set at 1 will be the first to be stopped in keeping with the sustainable time or the like. As the value of the priority (stopping order) increases, the priority ranking of a service becomes higher, and the service with the highest priority (stopping order) value will be the last to be stopped. The priority rankings of services may be determined, for example, in keeping with the Automotive Safety Integrity Level (ASIL) of the programs executed at the corresponding vehicle-mounted ECUs 2 when that service is performed. In other words, it is possible to set the priority rankings of services higher as the ASIL level of such services increases.

The “stopping threshold” management field stores the threshold that is referenced when stopping the service (service name) stored in the same record. The stopping thresholds correspond to the priority rankings of services (whose priorities are SA<SB<SC . . . <SN), so that as the numeric value of the priority (stopping order) of services increases, the value of the stopping threshold decreases (that is, the stopping thresholds are L1>L2>L3 . . . >LN). When a plurality of services are being executed, the control unit 11 of the vehicle-mounted apparatus 1 can identify the service with the lowest priority ranking out of the services currently being executed by comparing the sustainable time, which has been calculated based on the available power amount, the cumulative power usage, and the presently acquired current value, with the stopping threshold defined for each service. This enables the control unit 11 of the vehicle-mounted apparatus 1 to control the cutting off of the supplying of power to the vehicle-mounted ECUs 2 corresponding to the identified service with the lowest priority ranking, and enables the plurality of services presently being executed to be stopped in stages, starting with the service with the lowest priority ranking (priority).

The “stopped ECUs” management item stores the names or identification numbers (ECU IDs) of the vehicle-mounted ECUs 2 to be put into a stopped state or sleep state by processing that cuts off the supplying of power when the service (service name) stored in the same record is stopped. As indicated in the service table in the present embodiment, a single vehicle-mounted ECU (ECUa) may correspond to a plurality of services (SA, SB). As one example, a vehicle-mounted ECU (ECUa) performs processing relating to not only the service (SA) but also to the service (SB). In this case, if, when a service (SA) is stopped based on priority (the stopping order), control were performed to cut off the supplying of power not only to the vehicle-mounted ECUs (ECUb, ECUc) that correspond to the service (SA) only but also the supplying of power to the vehicle-mounted ECU (ECUa) that corresponds to other services, such as the service (SB), which should not be stopped, this would result in the affected other services also stopping, thereby causing an unavoidable drop in the value of such services. In contrast, by storing the names or the like of vehicle-mounted ECUs 2 that correspond to only the service to be stopped in the “stopped ECU” management field, it becomes possible for the control unit 11 of the vehicle-mounted apparatus 1 to efficiently identify vehicle-mounted ECUs 2 that correspond to only a service to be stopped and will not affect other services.

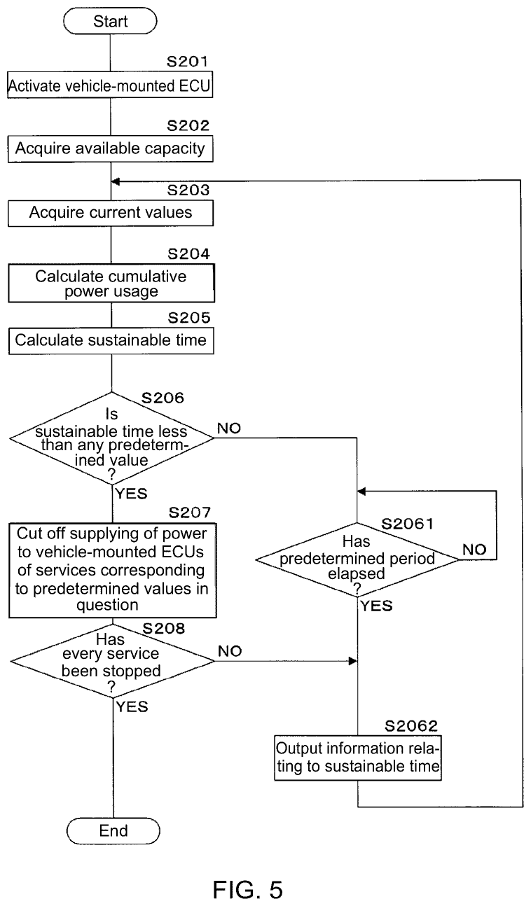

FIG. 5 is a flowchart depicting the processing of the control unit 11 in the vehicle-mounted apparatus 1. The control unit 11 of the vehicle-mounted apparatus 1 regularly performs the following processing in a state where generation of power (that is, recharging of the battery) by an alternator or the like is not possible, such as when the vehicle C is stopped (that is, when the IG switch 141 is off).

The control unit 11 of the vehicle-mounted apparatus 1 activates the corresponding vehicle-mounted ECUs 2 to execute a service (S201). In the same way as the first embodiment, the control unit 11 of the vehicle-mounted apparatus 1 acquires information relating to a plurality of services to be executed (a plurality of service start requests) by acquiring signals from switches connected to the input/output interface 14 or by acquiring communication data, such as CAN messages, via the communication unit 13. As one example, the control unit 11 of the vehicle-mounted apparatus 1 refers to a service table stored in the storage unit 12, identifies a plurality of vehicle-mounted ECUs 2 corresponding to each of the plurality of services to be executed, and transmits a wake-up signal to the identified plurality of vehicle-mounted ECUs 2. Alternatively, the control unit 11 of the vehicle-mounted apparatus 1 controls the power supplying cutoff units 52 provided on the power supplying lines 51 connected to the identified vehicle-mounted ECUs 2 to start supplying power (that is, to turn on the relays). By doing so, one or a plurality of corresponding vehicle-mounted ECUs 2 are activated (wake up) to execute the plurality of services.

The control unit 11 of the vehicle-mounted apparatus 1 acquires the available capacity that can be used to execute services (S202). The control unit 11 of the vehicle-mounted apparatus 1 acquires the value of the current flowing through the vehicle-mounted ECUs 2 corresponding to the services (S203). The control unit 11 of the vehicle-mounted apparatus 1 calculates the cumulative power usage based on the acquired current value (S204). The control unit 11 of the vehicle-mounted apparatus 1 calculates the sustainable time for which power can be supplied to the vehicle-mounted ECUs 2 corresponding to the services based on the available power amount, the cumulative power usage, and the presently acquired current values (S205). The control unit 11 of the vehicle-mounted apparatus 1 performs the processing in S202 to S205 in the same way as S102 to S105 in the first embodiment.

At this time, the control unit 11 of the vehicle-mounted apparatus 1 acquires the current values flowing through all the vehicle-mounted ECUs 2 (ECUa, ECUb, ECUc . . . ECUz) that were activated to execute the plurality of services and calculates the integral of the current values (F[C]=(a+b+c . . . +z)[A]*E[s]) and the cumulative power usage. The plurality of services to be executed may include a service (or “determined usage time service”) whose usage time is set in advance. In such case, the control unit 11 of the vehicle-mounted apparatus 1 may exclude the current value (power consumption) of vehicle-mounted ECUs 2 (or “determined usage time ECUs”) corresponding to the determined usage time services when determining whether each service is to continue. The control unit 11 of the vehicle-mounted apparatus 1 may detect the current values (c, d) flowing through the determined usage time ECUs and separately calculate a value (M[C]=(c+d)*P) obtained by multiplying the current values by the usage times (P[s]) of the determined usage time ECUs. The control unit 11 may then calculate the sustainable time (K) using a value obtained by subtracting the cumulative power usage (F_ALL) and the used capacity (M[C]) calculated for the determined usage time ECUs from the available capacity (H[C]). When calculating the sustainable time (K), the control unit 11 of the vehicle-mounted apparatus 1 divides by the current value ((a+b+c . . . +z)[A]) flowing through the vehicle-mounted ECUs 2 corresponding to all of the services being executed at the present time (which is to say, (H-F_ALL-M)/(a+b+c . . . +z)).

The control unit 11 of the vehicle-mounted apparatus 1 determines whether the sustainable time is less than any of the predetermined values (S206). As one example, the control unit 11 of the vehicle-mounted apparatus 1 refers to the service table stored in the storage unit 12 and determines whether the calculated sustainable time (K) is smaller (that is, less than a predetermined value) than the stopping thresholds (the predetermined values L1, L2, L3, . . . ) defined for any of the services. The stopping thresholds (predetermined values) for the plurality of services are defined in steps according to the priority rankings of the services. The service with the largest stopping threshold (predetermined value) is the service with the lowest priority ranking (or simply “priority”), and is therefore the service that will be stopped first. The control unit 11 of the vehicle-mounted apparatus 1 determines whether the sustainable time is less than any of the predetermined values, and by doing so determines whether there are any services currently being executed whose stopping thresholds (predetermined values) are equal to or greater than the current value of the sustainable time.

If the sustainable time is not less than any of the predetermined values (S206: NO), the control unit 11 of the vehicle-mounted apparatus 1 determines whether a predetermined period has elapsed (S2061). If the predetermined period has not elapsed (S2061: NO), the control unit 11 of the vehicle-mounted apparatus 1 performs loop processing to execute the processing of S2061 again. The control unit 11 of the vehicle-mounted apparatus 1 performs the processing of S2061 in the same way as S1061 in the first embodiment.

If the sustainable time is less than any of the predetermined values (S206: YES), the control unit 11 of the vehicle-mounted apparatus 1 cuts off the supplying of power to the vehicle-mounted ECUs 2 of the services corresponding to such predetermined values (S207). The control unit 11 of the vehicle-mounted apparatus 1 refers to the service table to identify the predetermined values in question, that is, out of the services being executed, each service (as one example, SA) whose stop threshold (predetermined value) is equal to or greater than the present value of the sustainable time (as one example, L1≥K) as a service to be stopped.

As one example, the control unit 11 of the vehicle-mounted apparatus 1 refers to the service table and identifies the vehicle-mounted ECUs 2 corresponding to the services to be stopped as vehicle-mounted ECUs 2 to which the supplying of power is to be cut off. The control unit 11 of the vehicle-mounted apparatus 1 outputs a sleep signal to the identified vehicle-mounted ECUs 2. Alternatively, the control unit 11 of the vehicle-mounted apparatus 1 controls the power supplying cutoff units 52 provided for the identified vehicle-mounted ECUs 2 to cut off the supplying of power (that is, to turn off the relays).

The vehicle-mounted ECU 2 for which processing to cut off the supplying of power has been performed in this manner enters a stopped or sleep state and does not receive power supplied from the power source apparatus 5, which effectively cuts off the supplying of power. Since the stopped ECUs management item in the service table stores the names or the like of the vehicle-mounted ECUs 2 that correspond only to a service to be stopped, the service in question can be stopped without this affecting other services.

The control unit 11 of the vehicle-mounted apparatus 1 associates the name of the stopped service with the time of stopping and stores such data in the storage unit 12. By storing data (that is, “service history data”) relating to the history of execution and stopping of a service in this way in the storage unit 12, the control unit 11 of the vehicle-mounted apparatus 1 can grasp which services are currently being executed.

The control unit 11 of the vehicle-mounted apparatus 1 determines whether every service has been stopped (S208). The control unit 11 of the vehicle-mounted apparatus 1 determines whether every service out of the plurality of services for which processing was executed in S201 has been stopped. The control unit 11 of the vehicle-mounted apparatus 1 stores data (that is, “service history data”) on the history of execution and stopping of services in the storage unit 12, and by referring to this service history data, can determine whether every service has been stopped. On determining that every service has been stopped (S208: YES), the control unit 11 of the vehicle-mounted apparatus 1 ends the series of processes.

If it is determined that not every service has been stopped (S208: NO), or if a predetermined period has elapsed (S2061: YES), the control unit 11 of the vehicle-mounted apparatus 1 outputs information relating to the sustainable time (S2062). When not every service has stopped, that is, when any of the services is still being executed, the control unit 11 of the vehicle-mounted apparatus 1 calculates the sustainable time for each service out of the one or plurality of services presently being executed. Alternatively, the control unit 11 of the vehicle-mounted apparatus 1 calculates the sustainable time for each combination of two or more services out of the plurality of services presently being executed.

The control unit 11 of the vehicle-mounted apparatus 1 may also refer to the service table to identify the vehicle-mounted ECUs 2 corresponding to each service currently being executed and calculate the sustainable time for each service and the sustainable time for combinations of two or more services based on the current value flowing through the identified vehicle-mounted ECUs 2 (that is, the power consumption) and the remaining power amount (H-F_ALL). When doing so, the control unit 11 of the vehicle-mounted apparatus 1 may calculate the sustainable time by using a value obtained by subtracting the used capacity (M[C]) calculated for determined usage time ECUs from the remaining power amount (H-F_ALL).

The control unit 11 of the vehicle-mounted apparatus 1 outputs information relating to the respective sustainable times calculated in this way, for example, via the vehicle-mounted network 3 to an HMI apparatus, such as a display apparatus, mounted in the vehicle C or via an external communication apparatus with a wireless function to a mobile terminal or the like held by the operator of the vehicle C. After executing the processing in S2062, the control unit 11 of the vehicle-mounted apparatus 1 performs loop processing to execute the processing of S203 again. This makes it possible to periodically notify the operator of the vehicle C of information relating to each of the plurality of services being executed (that is, the sustainable times of the respective services being executed).

### THIRD EMBODIMENT

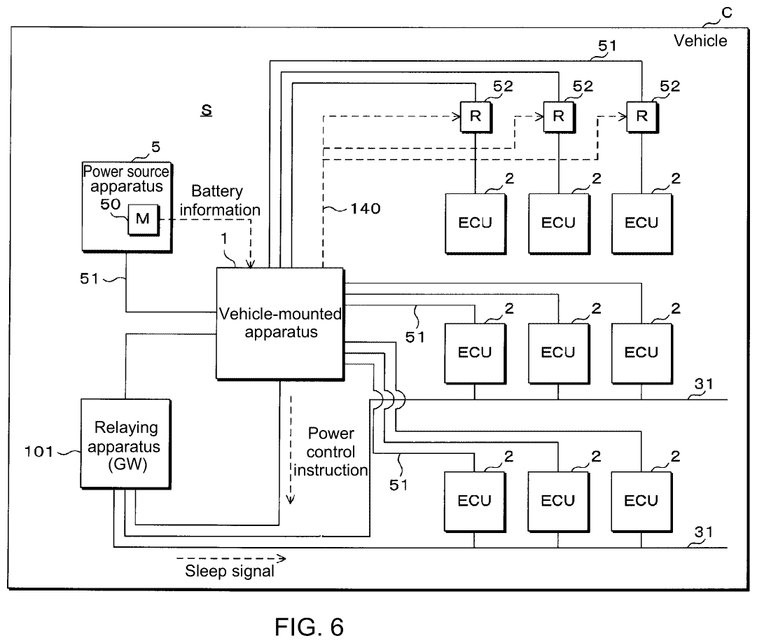

FIG. 6 is a schematic diagram depicting the configuration of a vehicle-mounted system S including a vehicle-mounted apparatus 1 and the like according to a third embodiment (where a relaying apparatus 101 outputs a sleep signal). The vehicle-mounted system S in the present embodiment includes the relaying apparatus 101 as a separate apparatus from the vehicle mounted apparatus 1. In the same way as the vehicle-mounted apparatus 1 according to the first embodiment, the relaying apparatus 101 includes a control unit, a storage unit, and a communication unit. In the same way as in the first embodiment, the vehicle-mounted apparatus 1 functions as a power control apparatus and a power distributing apparatus. The vehicle-mounted apparatus 1 and the relaying apparatus 101 are connected by the power supplying line 51, and the vehicle-mounted apparatus 1 may also distribute power to the relaying apparatus 101. The vehicle-mounted apparatus 1 and the relaying apparatus 101 are connected to each other via the vehicle-mounted network 3 so as to be capable of communicating with each other.

When executing control to cut off the supplying of power to the vehicle-mounted ECUs 2 corresponding to a service to be stopped, the vehicle-mounted apparatus 1 controls the power supplying cutoff units 52 to cut off the supplying of power (that is, to turn off the relays) for the vehicle-mounted ECUs 2 provided with such power supplying cutoff units 52. In addition, when executing control to cut off the supplying of power to the vehicle-mounted ECUs 2 corresponding to a service to be stopped, the vehicle-mounted apparatus 1 outputs, to the relaying apparatus 101, a power control instruction that identifies the vehicle-mounted ECUs 2 for which the supplying of power is to be cut off. The relaying apparatus 101 that has acquired a power control instruction from the vehicle-mounted apparatus 1 outputs a sleep signal to the vehicle-mounted ECUs 2 that correspond to a service to be stopped, that is, the vehicle-mounted ECUs 2 for which the supplying of power is to be cut off in keeping with the power control instruction.

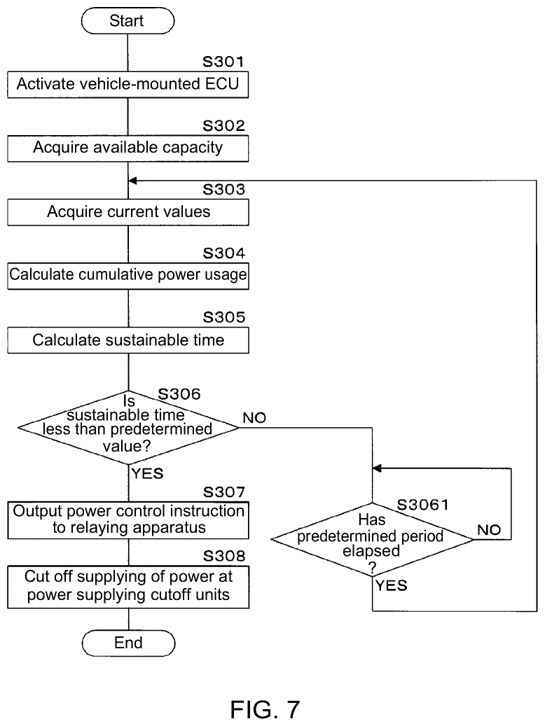

FIG. 7 is a flowchart depicting the processing of the control unit 11 of the vehicle-mounted apparatus 1. This flowchart depicts the processing of the control unit 11 of the vehicle-mounted apparatus 1. The control unit 11 of the vehicle-mounted apparatus 1 regularly performs the following processing in a state where generation of power (that is, recharging of the battery) by an alternator or the like is not possible, such as when the vehicle C is stopped (that is, when the IG switch 141 is off). The control unit 11 of the vehicle-mounted apparatus 1 performs the processing from S301 to S3061 in the same way as the processing from S101 to S1061 in the first embodiment.

If the sustainable time is less than a predetermined value (S306: YES), the control unit 11 of the vehicle-mounted apparatus 1 outputs a power control instruction to the relaying apparatus 101 (S307). By outputting the power control instruction to the relaying apparatus 101 as processing relating to supplying of power, the control unit 11 of the vehicle-mounted apparatus 1 causes the relaying apparatus 101 to execute processing that outputs a sleep signal to the vehicle-mounted ECUs 2 corresponding to a service. The power control instruction includes the ECU IDs and the like of the vehicle-mounted ECUs 2 to which the supplying of power is to be cut off, and in keeping with this power control instruction, the relaying apparatus 101 outputs a sleep signal to the vehicle-mounted ECUs 2 corresponding to the service to be stopped, that is, the vehicle-mounted ECUs 2 to which the supplying of power is to be cut off.

The control unit 11 of the vehicle-mounted apparatus 1 executes control to cut off the supplying of power to the power supplying cutoff units 52 (S308). For vehicle-mounted ECUs 2 which are provided with power supplying cutoff units 52 and for which the supplying of power is to be cut off, the control unit 11 of the vehicle-mounted apparatus 1 controls such power supplying cutoff units 52 to cut off the supplying of power (that is, to turn off the relays). In this way, the control unit 11 of the vehicle-mounted apparatus 1 performs the processing in S307 and S308 relating to the cutting off of power.

### FOURTH EMBODIMENT

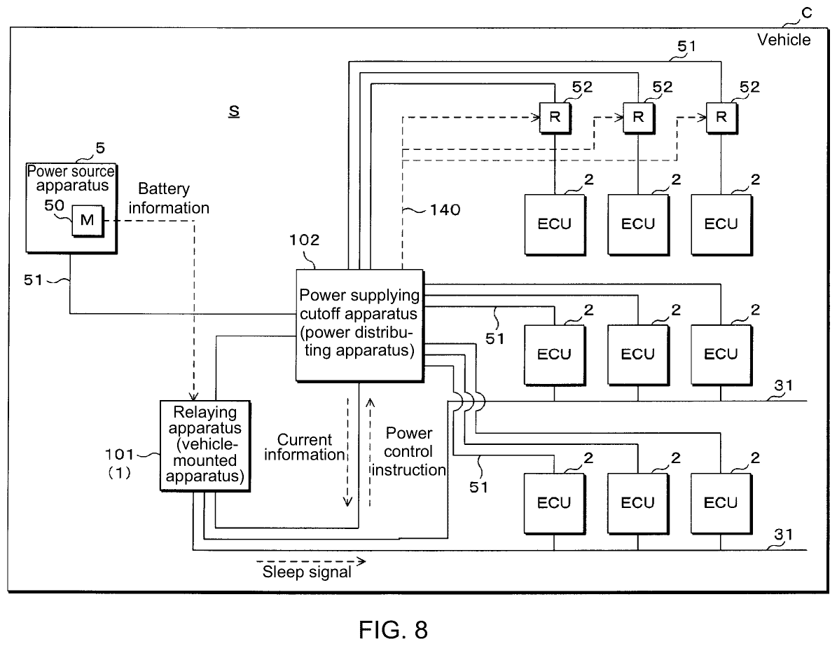

FIG. 8 is a schematic diagram depicting the configuration of a vehicle-mounted system S including a vehicle-mounted apparatus 1 and the like according to the fourth embodiment (where power control is implemented by a relaying apparatus 101). The vehicle-mounted system S according to the present embodiment includes the relaying apparatus 101 as the vehicle-mounted apparatus 1 and further includes a power supplying cutoff apparatus 102 that functions as a power distributing apparatus. Like the vehicle-mounted apparatus 1 according to the first embodiment, the relaying apparatus 101 includes a control unit, a storage unit, and a communication unit. In the present embodiment, the relaying apparatus 101 functions as the vehicle-mounted apparatus 1 (a power control apparatus) according to the first embodiment. That is, the vehicle-mounted apparatus 1 that functions as a power control apparatus corresponds to the relaying apparatus 101.

The relaying apparatus 101 communicates with the power source management unit 50 in the same manner as the vehicle-mounted apparatus 1 according to the first embodiment to acquire battery information of the power source apparatus 5. Like the vehicle-mounted apparatus 1 according to the first embodiment, the power supplying cutoff apparatus 102 includes a control unit, a storage unit, an input/output interface, and a communication unit, and further includes branch electric wires 15 and current detecting units 151. Distribution of power to the relaying apparatus 101 (the vehicle-mounted apparatus 1) may be performed by the power supplying cutoff apparatus 102 (a power distributing apparatus), or the relaying apparatus 101 (the vehicle mounted apparatus 1) may be connected to the power source apparatus 5 or a fuse box or the like without being connected via the power supplying cutoff apparatus 102 (a power distributing apparatus).

The relaying apparatus 101 that functions as a power control apparatus (the vehicle-mounted apparatus 1) acquires the current values (or “current information”) of currents flowing through the vehicle-mounted ECUs 2 corresponding to a service from the power supplying cutoff apparatus 102. Like the vehicle-mounted apparatus 1 according to the first embodiment, the relaying apparatus 101 determines whether to continue supplying power to the vehicle-mounted ECUs 2 corresponding to a service based on the current values (current information) acquired from the power supplying cutoff apparatus 102 and performs processing relating to the supplying of power (that is, control to cut off the supplying of power) in keeping with the determination result.

The relaying apparatus 101 outputs a sleep signal to the vehicle-mounted ECUs 2 corresponding to a service to be stopped to execute control that cuts off the supplying of power. In addition, the relaying apparatus 101 outputs a power control instruction to the power supplying cutoff apparatus 102 that identifies the vehicle-mounted ECUs 2 to which the supplying of power is to be cut off, which causes the power supplying cutoff apparatus 102 to execute processing that cuts off the supplying of power at the power supplying cutoff units 52. In keeping with the power control instruction, the power supplying cutoff apparatus 102 controls the power supplying cutoff units 52 of the vehicle-mounted ECUs 2 corresponding to the service to be stopped to cut off the supplying of power (that is, to turn off the relays).

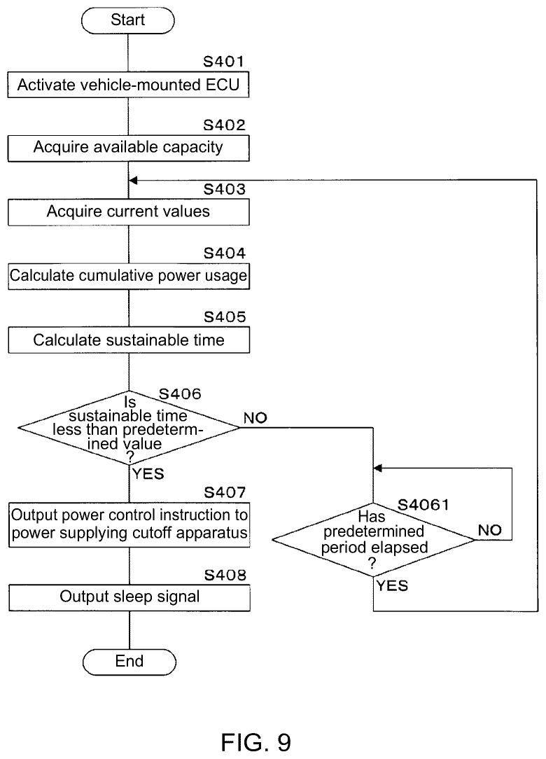

FIG. 9 is a flowchart depicting the processing of the control unit of the vehicle-mounted apparatus 1 (the relaying apparatus 101). This flowchart depicts the processing of the control unit 11 of the vehicle-mounted apparatus 1. The control unit 11 of the vehicle-mounted apparatus 1 regularly performs the processing described below in a state where the generation of power (that is, recharging of the battery) by an alternator or the like is not possible, such as when the vehicle C is stopped (that is, when the IG switch 141 is off). In the present embodiment, the relaying apparatus 101 performs a series of processes as the vehicle-mounted apparatus 1. The control unit of the relaying apparatus 101 (the vehicle-mounted apparatus 1) performs the processing from S401 to S4061 in the same way as the processes S101 to S1061 in the first embodiment. When performing these processes, the control unit of the relaying apparatus 101 acquires the current values of currents flowing in each of the vehicle-mounted ECUs 2 corresponding to a service from the power supplying cutoff apparatus 102 which functions as a power distributing apparatus.

If the sustainable time is less than the predetermined value (S406: YES), the control unit of the relaying apparatus 101 outputs a power control instruction to the power supplying cutoff apparatus 102 (S407). By outputting a power control instruction to the power supplying cutoff apparatus 102, the control unit of the relaying apparatus 101 causes the power supplying cutoff apparatus 102 to execute a process of cutting off the supplying of power at the power supplying cutoff units 52. The power control instruction includes the ECU IDs or the like of the vehicle-mounted ECUs 2 to which the supplying of power is to be cut off, and the power supplying cutoff apparatus 102 identifies the vehicle-mounted ECUs 2 to which the supplying of power is to be cut off based on the power control instruction acquired from the relaying apparatus 101. The power supplying cutoff apparatus 102 performs control to cut off the supplying of power (to turn off the relays) at the power supplying cutoff units 52 of the identified vehicle-mounted ECUs 2.

The control unit of the relaying apparatus 101 outputs a sleep signal to the vehicle-mounted ECUs 2 corresponding to the service (S408). The control unit of the relaying apparatus 101 outputs the sleep signal via the vehicle-mounted network 3 to the vehicle-mounted ECUs 2 corresponding to the service to be stopped. In this way, the control unit of the relaying apparatus 101 performs the processing of S407 and S408 relating to the cutting off of power.

The embodiments disclosed above are exemplary in all respects and should not be regarded as limitations on the present disclosure. The scope of the present disclosure is indicated by the range of the patent claims, not the wording used above, and is intended to include all changes within the meaning and scope of the patent claims and their equivalents.

The individual claims listed in the range of the patent claims may be combined with each other regardless of the indicated claim dependencies. The range of the patent claims may contain multiple dependent claims that are dependent on a plurality of claims. Such multiple dependent claims may depend on other multiple dependent claims. Even if multiple dependent claims that depend on other multiple dependent claims have not been indicated, this is not a limitation on multiple dependent claims that depend on multiple dependent claims.

1. A vehicle-mounted apparatus that is mounted in a vehicle and is connected to vehicle-mounted ECUs, which are connected to a vehicle-mounted network, so as to communicate with the vehicle-mounted ECUs,
the vehicle-mounted apparatus comprising a control unit configured to perform processing relating to supplying of power to the vehicle-mounted ECUs,
wherein the control unit:
acquires a current value of a current flowing through a vehicle-mounted ECU corresponding to a service executed in the vehicle;
acquires an available capacity, which can be used to execute the service, of a power source apparatus mounted in the vehicle;
determines whether to continue supplying power to the vehicle-mounted ECU corresponding to the service based on the acquired available capacity and the current value; and
performs processing relating to supplying of power in keeping with a determination result.

2. The vehicle-mounted apparatus according to claim 1,
wherein a power supplying cutoff unit for cutting off a supplying of power from the power source apparatus is provided for the vehicle-mounted ECU corresponding to the service, and
the processing relating to the supplying of power by the control unit includes control of the power supplying cutoff unit to cut off the supplying of power.

3. The vehicle-mounted apparatus according to claim 1, wherein the processing by the control unit relating to the supplying of power includes processing that outputs a sleep signal via the vehicle-mounted network to a vehicle-mounted ECU corresponding to the service.

4. The vehicle-mounted apparatus according to claim 1,
wherein the control unit
acquires current values, which are cyclically detected, during execution of the service,
calculates cumulative power usage based on the acquired plurality of current values,
calculates a sustainable time, for which supplying of power to the vehicle-mounted ECU corresponding to the service is sustainable, based on the available capacity, the cumulative power usage, and presently acquired current values, and
executes processing for cutting off supplying of power to the vehicle-mounted ECU corresponding to the service when the calculated sustainable time is below a predetermined value.

5. The vehicle-mounted apparatus according to claim 1,
wherein a plurality of services are executed at the vehicle, and
the control unit identifies vehicle-mounted ECUs to which supplying of power is to be cut off in keeping with priority rankings set for the plurality of services, and performs processing that cuts off the supplying of power to the identified vehicle-mounted ECUs.

6. The vehicle-mounted apparatus according to claim 5,
wherein the control unit cyclically calculates a sustainable time for supplying of power to the vehicle-mounted ECUs corresponding to each of the plurality of services and outputs information relating to the calculated sustainable times for each of the services, and
the information relating to each of the sustainable times includes a sustainable time for when only one of the services is executed and a sustainable time for when a plurality of the services are executed in combination.

7. The vehicle-mounted apparatus according to claim 1,
wherein a relaying apparatus for relaying communication data to be transmitted and received between the plurality of vehicle-mounted ECUs is connected to the vehicle-mounted network, and
as the processing relating to the supplying of power, the control unit outputs a power control instruction to the relaying apparatus to cause the relaying apparatus to execute processing for outputting a sleep signal to a vehicle-mounted ECU corresponding to the service.

8. The vehicle-mounted apparatus according to claim 1,
wherein the control unit performs processing for relaying communication data that is transmitted and received between a plurality of vehicle-mounted ECUs,
the vehicle-mounted ECU corresponding to the service is provided with a power supplying cutoff unit for cutting off supplying of power from the power source apparatus,
a power supplying cutoff apparatus, which is conductively connected to the power supplying cutoff unit, is mounted in the vehicle,
the control unit
acquires a current value of a current flowing in the vehicle-mounted ECU corresponding to the service from the power supplying cutoff apparatus,
determines whether to continue supplying power to the vehicle-mounted ECU corresponding to the service based on the acquired available capacity and the current value, and
performs processing relating to supplying of power in keeping with a result of the determining, and
the processing relating to supplying of power includes:
processing that outputs, via the vehicle-mounted network, a sleep signal to the vehicle-mounted ECU corresponding to the service; and
processing that outputs a power control instruction to the power supplying cutoff apparatus to cause the power supplying cutoff apparatus to execute processing that cuts off supplying of power at the power supplying cutoff unit.

9. An information processing method that causes a computer connected to vehicle-mounted ECUs, which are connected to a vehicle-mounted network, so as to communicate with the vehicle-mounted ECUs to execute processing comprising:
acquiring a current value of a current flowing through a vehicle-mounted ECU corresponding to a service executed in the vehicle;
acquiring an available capacity, which can be used to execute the service, of a power source apparatus mounted in the vehicle;
determining whether to continue supplying power to the vehicle-mounted ECU corresponding to the service based on the acquired available capacity and the current value; and
performing processing relating to supplying of power in keeping with a result of the determining.

10. A program that causes a computer connected to vehicle-mounted ECUs, which are connected to a vehicle-mounted network, so as to communicate with the vehicle-mounted ECUs to execute processing comprising:
acquiring a current value of a current flowing through a vehicle-mounted ECU corresponding to a service executed in the vehicle;
acquiring an available capacity, which can be used to execute the service, of a power source apparatus mounted in the vehicle;
determining whether to continue supplying power to the vehicle-mounted ECU corresponding to the service based on the acquired available capacity and the current value; and
performing processing relating to supplying of power in keeping with a result of the determining.

11. The vehicle-mounted apparatus according to claim 2,
wherein the control unit
acquires current values, which are cyclically detected, during execution of the service,
calculates cumulative power usage based on the acquired plurality of current values,
calculates a sustainable time, for which supplying of power to the vehicle-mounted ECU corresponding to the service is sustainable, based on the available capacity, the cumulative power usage, and presently acquired current values, and
executes processing for cutting off supplying of power to the vehicle-mounted ECU corresponding to the service when the calculated sustainable time is below a predetermined value.

12. The vehicle-mounted apparatus according to claim 3,
wherein the control unit
acquires current values, which are cyclically detected, during execution of the service,
calculates cumulative power usage based on the acquired plurality of current values,
calculates a sustainable time, for which supplying of power to the vehicle-mounted ECU corresponding to the service is sustainable, based on the available capacity, the cumulative power usage, and presently acquired current values, and
executes processing for cutting off supplying of power to the vehicle-mounted ECU corresponding to the service when the calculated sustainable time is below a predetermined value.

13. The vehicle-mounted apparatus according to claim 2,
wherein a plurality of services are executed at the vehicle, and
the control unit identifies vehicle-mounted ECUs to which supplying of power is to be cut off in keeping with priority rankings set for the plurality of services, and performs processing that cuts off the supplying of power to the identified vehicle-mounted ECUs.

14. The vehicle-mounted apparatus according to claim 3,
wherein a plurality of services are executed at the vehicle, and
the control unit identifies vehicle-mounted ECUs to which supplying of power is to be cut off in keeping with priority rankings set for the plurality of services, and performs processing that cuts off the supplying of power to the identified vehicle-mounted ECUs.
